(19) United States
(12) Patent Application Publication
(10) Pub. No.: US 2006/0140445 A1
(43) Pub. Date: Jun. 29, 2006

(54) Method and apparatus for capturing digital facial images optimally suited for manual and automated recognition

(76) Inventor: Francis John Cusack JR., Groton, MA (US)

Correspondence Address: FRANCIS CUSACK, 174 DUCK POND DRIVE, GROTON, MA, 01450, US

(21) Appl. No.: 11/084,807

(22) Filed: Mar. 21, 2005

Related U.S. Application Data
(60) Provisional application No. 60/555,063, filed on Mar. 22, 2004.

(51) Int. Cl. G06K 9/00

(52) U.S. Cl. 382/103; 382/118

(57) ABSTRACT

The invention details how to capture very high quality face images in demanding environments for either manual review or automated recognition algorithms. By dynamically controlling a host of imaging parameters and segmenting the field of view into regions just around the faces, or one region per face in the field of view, a face image may be generated of superior quality to that which is produced from an imaging system that takes a more global approach to image parameter adjustment. Specific face regions are given imaging priority, at the expense of other regions of lower priority. Furthermore, face regions may be tracked as a function of time and space, thereby sustaining or improving face image quality as the face location migrates with the field of view.

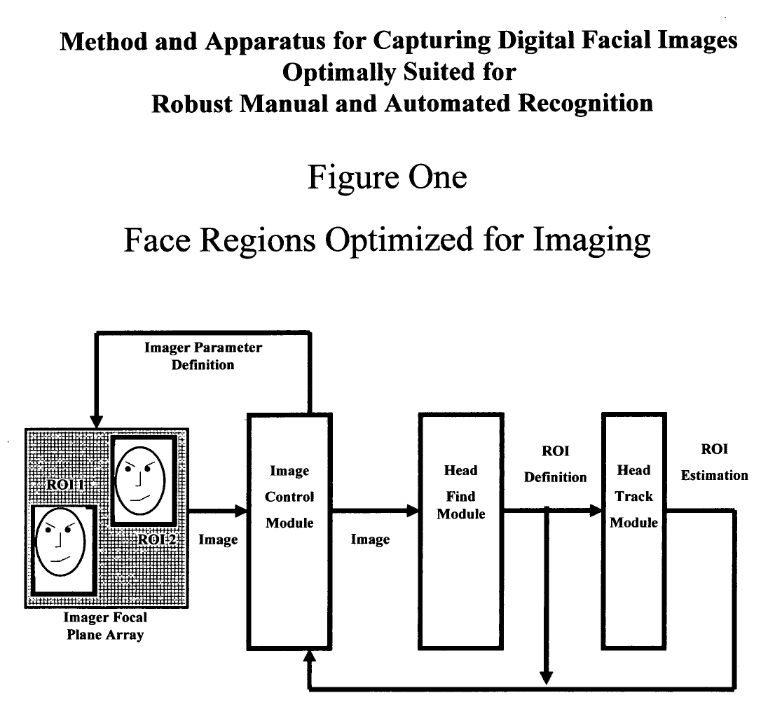

### REFERENCE TO RELATED APPLICATIONS

This application is based on, claims the benefit of the filing date of, and incorporates by reference, the provisional patent application Ser. No. 60/555,063 filed on Apr. 5, 2004.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None. BACKGROUND OF THE INVENTION

An increasing number of products, systems and solutions require either automated (using a processor and algorithms) or manual (man-in-the-loop) reviewing a digital images or digital video of a human face as fundamental to the solution. Whether it be high technology surveillance systems, video conference systems, consumer still and video cameras, bank Automatic Teller Machines (ATMs) or even cell phones, presenting a user or system with a high quality digital image of a human face for either manual or automated review will continue to be central to many of today's products, and many more of tomorrow's. Furthermore, in the interest of improved automated face recognition, there is a need to provide the ever-increasing number of automated facial recognition engines with facial images of improved quality, particularly across widely varying environmental conditions.

The last decade has seen explosive growth in public awareness and use of biometrics in general, and in automated facial recognition in particular. Facial recognition has several important strengths relative to competing biometrics; it is the most intuitive to review manually, it is the least intrusive, does not require physical contact to capture the biometric signal, and can be used to good effect on the large number of existing facial databases such as passport, drivers' licenses, and employee databases. While the growth of facial recognition systems will no doubt continue to expand, and may well emerge as the dominant biometric, the widespread adoption of these systems has been held back by a failure to demonstrate repeatable and highly accurate performance. Core to this deficiency is the face finding and matching algorithms' dependency on very high image quality passed from the imager to the facial recognition engine. Ironically, most of the research dollars spent on the technology is on the software that finds and matches faces, while the source of the data that feeds these sophisticated algorithms is generally off the shelf and low cost conventional video cameras that are not well suited to the task.

With current art imagers, such as CCD cameras that are ubiquitous in consumer and security markets, analog signal data for each pixel is raster shifted off the imager and serially digitized to construct a digital image. A host of imager optimization parameters such as sensor integration time (electronic shutter speed), amplifier gain (contrast), amplifier DC offset (brightness), backlight compensation, gamma (amplitude compression) and many others are selected by a local processor in accordance with pre-set constraints defined by either the manufacturer or the user. But this small number of pre-set parameters can not produce ideal face images because the camera simply can not be sufficiently preprogrammed in a cost effective way to adapt to every conceivable combination of face and surrounding environment.

With current art, for example, the grouping of the individual sensing elements may be segregated into fixed regions (such as a band along the top [sky] and band along the bottom [sand]) to achieve a prescribed compromise of the competing imaging requirements. By coupling preset imaging parameters with prescribed field of view segregation, a set of canned imager parameters may be made available to the user as user selectable modes. This affords the user the flexibility to manually select the imaging mode best suited to the anticipated subject and environment scene dynamics. For example, this is commonly seen on digital still and video cameras as Sports Mode (tuned for high speed), Portrait Mode (tuned for low speed), Stage Mode (tuned for strong overhead lighting), Ski Mode (tuned for strong lighting below faces) and others. While this technique has proven to yield an improvement over cameras without any presets, and is more convenient than manually computing and setting several parameters as in early model 35 mm cameras, it nevertheless represents a very small number of operational modes left to cope with an infinite number of challenging scenes. Furthermore, as this tradeoff is fixed in time and space (geometry of the imager), it is not able to adapt to a moving target (e.g. face). Therefore a face that is optimally imaged in one location, such as the center of the field of view, may be imaged very poorly as it moves to another location within the scene, such as to the top, bottom or sides of the field of view. Furthermore, if the imager has to cope with multiple faces occupied very different locations, a pre-set approach designed to optimize a single spatial region will not produce good face images on faces outside of that region.

### BRIEF SUMMARY OF THE INVENTION

The invention provides for a higher quality digital image of a human's face to be captured and forwarded for display, storage or submittal to an automated facial recognition system. This invention will produce an improvement to the overall performance of systems based on manual (e.g. human) still image and video review, particularly when there are multiple faces in the imager's field of view, and will unlock the potential of automated facial recognition systems that have been held back by sensitivities to poor image quality.

### BRIEF DESCRIPTION OF THE SEVERAL VIEWS OF THE DRAWING

FIGURE One illustrates a functional block diagram of the device consisting of the sensor, image control module, head find module and head track module.

Sensor: The device is comprised of photosensitive sensing elements that convert incident photons into electrons. In the preferred embodiment, each individual sensing element will have a dedicated digitizer, so that a purely digital image may be produced by combining all or a subset of the sensing elements.
Image Control Module: This module controls all of the imaging parameters that can be adjusted to optimize a particular region of interest (which may be the whole scene, a subset or many subsets). Parameters that are typically adjusted in some fashion may be but are not limited to; sensor gain and DC offset of the digitizer amplifier, integration time, color balance, amplitude compression. The myriads of imaging parameters are optimized specifically for the region(s) about the face(s), and thereby are not sensitive to the effects of adjacent and dominating scene content (such as bright lights, sunlight and glare). Those skilled in the art will readily appreciate that any image control and optimization parameter or techniques that are currently used in today's state of the art may be applied here to individual sensing elements and to groups of elements (e.g. spectral sensitivity, pixel binning, anti bloom, etc . . . ).
Head Find Module: This module determines what region or regions within the total field of view may contain a head, and therefore a face. It may utilize any method or combination of methods in determining the presence of a head, including but not limited to template matching, color information, spatial domain techniques and motion detection. Those skilled in the art will appreciate that there are many ways to effect a head location, and the examples give here are merely representative of a subset of what may be employed. Multiple head and face regions may peacefully coexist; even overlap and each face region will be individually optimized such that the face contained within is optimally imaged.
Head Track Module: The Head Track Module may leverage state of the art tracking algorithms and techniques to provide robust face tracking even in cluttered, fast moving and complex scenes. One a head location is determined the Head Track Module uses tracking techniques to calculate the expected location and size of the head in the next frame or succession of frames. The head track module will take into account the size, location, velocity and acceleration of the head, which may also include pose angle, angle velocity and acceleration data. The Head Track Module orchestrates all this data, along with desired frame rate and data from the sensor, image optimization module and the head find module to keep pace with the moving face and dynamically support optimal face imaging. It will also anticipate when the face may be obscured, either by other faces in a multiple track scenario, or by moving and stationary objects within the scene. A processor detects the head location(s), and passes on the ROI data to the image optimization module to ensure optimal face imaging on the next frame.

### DETAILED DESCRIPTION AND PREFERRED EMBODIMENT OF THE INVENTION

This invention will provide greatly improved digital still and video images specifically of faces for applications requiring manual review, automated review, or a combination of both. The invention takes advantage of a new class of digital imager with individually addressable imaging elements, such as but not limited to, Complementary Metal Oxide Semiconductor (CMOS) imagers, which are now competing with conventional Charge Couple Device (CCD) imagers that have become the de facto standard imager since solid state imagers supplanted tube based imagers. Those skilled in the art of image system design will appreciate that the premise for this invention is based on an imager with individually programmable imaging elements without regard to the imager's spectral sensitivity, imaging element density, imager size or the specific material and construction techniques used in fabricating such an imager. For the purposes of this application, CMOS imagers operating in the visible spectrum will be used as an example of such an imager.

There exist a number of important technical differences between CMOS and CCD imagers, several of which can be exploited for improved imaging of human faces. It will be shown that a means has been devised to capture multiple faces within the imager field of view simultaneously, with improved face image quality through more optimal settings of camera imaging parameters, and at a higher frame rate than conventional cameras.

The improvements in face imaging will produce face images with less motion induced blurring, reduced sensitivity to background lighting for more consistent and optimal brightness and contrast within the facial region, and the ability to preserve these improvements even as the faces move through the camera's field of view and through environments that historically have posed a challenge to contemporary imagers.

While the preferred embodiment is described herein, it is understood that one skilled in the art may derive variations and alternative configurations. In the spirit of this invention, it is assumed that concepts germane to this invention will be afforded protection. The preferred embodiment fundamentally brings together the functionality of a discrete imager (or sensor) with individually addressable imaging elements (pixels), such as a CMOS imager, a local processor, and local software capable of running basic algorithms for determining head locations and associated optimal imaging parameters. Together, these components comprise a purpose built camera ideally suited to finding a face or multiple faces within the field of view, and to making the necessary calculations and adjustments to ensure that each face is individually and optimally imaged for improved display, storage or automated recognition.

In the absence of head like object within the field of view, the camera will behave as a conventional imager (current art) and the Image Control Module will dynamically adjust the camera's imaging parameters to present the best global scene as represented by the entire field of view. This video will be forwarded to the Head Find Module, where the camera will search for face like objects using algorithms that may be applied to either a single frame of video data, or to successive frames of data. Techniques to achieve this are well understood and well represented by prior art, and may consist of motion detection, blob detection and segmentation, edge detection, head template matching, and other image processing techniques. Furthermore, a combination of these techniques may be integrated to produce a more robust and accurate head detection.

Once a head has been detected, the approximate size, location, and velocity of the head is passed on to the Head Tracking Module. Here a unique head ROI is created for each head based on the head size and location data received by the Head Find Module, and the associated ROI data is passed back to the Image Control Module so that control may be applied to the imaging parameters to produce the optimal image specifically within the aforesaid ROI. This represents an improvement over existing art, where large fixed regions within the field of view are weighted to optimize the image, without consideration for potentially smaller objects of interest (such as a head and face) whose data may not be weighted sufficiently and may overlap the fixed regions. By taking advantage of the individually addressable imaging elements, each pixel within the ROI can be optimized in accordance with the ROI's unique requirements, regardless of the ROI's size or location on the imager. Examples of imaging parameters that may be optimized in real time for the specific face ROI include, but are not limited to:

On-Chip Binning
Binning is a process of combining the charges in adjacent pixels on the sensor, prior to readout, which effectively increases the size of the aggregate pixel. The net result is a charge that is the sum of the charges of the binned pixels which yields an improved signal-to-noise ratio. Binning quantities are user-set in any aspect-for example 2×2, 4×4, 1×100, etc.

Antiblooming
During an exposure photons are collected in the pixels, or wells, of the sensor. Sometimes there may be so much light that some of the wells fill with electrons and overflow. When this happens a bright streak appears along the column, and a bright bloom may appear around the overflowing pixel. This phenomena is called blooming. Antiblooming counters this by draining off the excess electrons before they flow into adjacent pixels. This is typically used when there is a very bright object in an image.

Dynamic Range Analog to Digital Convervter (ADC)
To maintain high integrity of the data, the ADC should be located in the camera, and while the total dynamic range may be 10 bit, 12 bit or even more, the dynamic range used will be dynamically adapted for optimal face imaging. These A/D converters should provide low quantization noise and high photometric accuracy.

Fast Focus and Display Mode
Downloading the image data at a low data amplitude resolution, such as 8-bit ADC, located in the camera head, provides fast images for focusing and framing. As the focus-mode data is 8-bits, no computer processing is required and the data may is sent directly to the video RAM for display on a monitor. In addition, the software automatically commands the camera to download only the pixels in the face region sub-window or sub-windows. These features combine to yield fast image for display.

Multiple Readout Rates
The imager readout rate is automatically computed based on face location, speed and background scene data (for example 25K, 50K, 100K, or 200K pixels per second) to best match the camera performance to face imaging. Slower readout rates yield reduced noise and increased sensitivity. Faster readout rates reduce the time it takes to download an image.

Multiple Gain Settings
Amplifier gain affects the contrast. Automatic and optimal selection of the software settings for the gain prior to the ADC allows maximum use of the dynamic range of the ADC. Applying higher gain to a weak signal results in a larger voltage range being presented to the ADC. This yields higher photometric resolution and reduces the quantization noise by utilizing more significant bits of the ADC.

Programmable Offset
The amplifier DC offset affects the brightness. Automatic and optimal selection of the of the software settings for the offset is used to position the zero value to make optimum use of the ADC by generating more significant bits on small values. Using offset with gain allows detailed study of specific signal-levels of interest. For example, if the signal-level of interest has a brightness range of say, half of the ADC dynamic range, the offset can be used to move that signal level down. Then more gain can be applied to the signal levels of interest without exceeding the dynamic range of the ADC.

Sub-Windowing for Face Region of Interest
A sub-window is created by commanding the camera to readout only the pixels within a specified face area, or sub-window, of the imager. This is typically used to decrease the readout time or eliminate unnecessary data by reducing the number of pixels that have to be converted, downloaded and stored. The sub-window may be set by the user or automatically by the processor to any size and location on the sensor.

Programmable Camera Settings
The imager voltages, amplifier offsets, and the sequencer waveform timing are set dynamically and automatically from the processor. This not only allows for quick and precise adaptive tuning of the camera, but allows the camera to easily optimize settings for a specific engagement or environment. Default settings may be stored in an initialization file located in software either local to the camera or on a support computer.

Spectral Sensitivity
Some sensors provide the ability to make adjustments to how sensitive or responsive the sensor is a function of wavelength. This is of particular interest for automated recognition, as it may be beneficial for a particular set of face acquisition or recognition algorithms to operate on images produced in a specific spectral region (e.g. red, near IR). The spectral sensitivity will be automatically and dynamically set to ensure optimal face imaging and recognition.

The Head Tracking Module may produce an estimation of the probable position of the head ROI in the next frame of data based on the velocity data of the current and previous frames. Well-established techniques such as Kalman filters may be employed to this end, although designers should not limit themselves to conventional estimation methods. Furthermore, the Head Tracking Module may manage multiple head ROIs simultaneously. The anticipated ROI location and size for each ROI is in turn passed on to the Image Control Module. Allowances may be made within both the Head Tracking Module and the Image Control Module to account for obscuration of overlapping ROIs. Given this dynamic condition, each face within its unique head ROI, regardless of its size and position with the field of view, is simultaneously afforded the optimal setting of critical imaging parameters.

The frame rate for each ROI may exceed conventional video frame rates (30 frames/second NTSC and 25 frames/second PAL) while not exceeding standard video bandwidths. For example, if a single head ROI is instantiated that comprises 20% of the imagers pixels, the ROI can be read out at five times standard frame rate without exceeding the original bandwidth. This has appeal in dynamic engagements where a ROI is moving with sufficient velocity to induce blurring of the detected image. Increasing the ROI frame rate will reduce facial blurring and facilitate improve imaging and subsequent recognition. This technique is also attractive for slow or non-moving faces in an under lit environment. As the amount of light reaching the imagers decreases, the imager will respond by increasing the electronic amplification of the image. At this point the imager will be Johnson Noise limited, which means that the electronic amplifier noise injected into the image data as a function of the ambient temperature and signal gain dominates the image. Because the noise from frame to frame is statistically uncorrelated, it can be averaged out across multiple frames. This technique may be applied to successive frames of a ROI where the facial data is relatively static, but the image data is dominated by noise. Averaging across several successive frames will suppress the noise while not tainting the facial image data, thereby producing a more noise free image that will produce higher subsequent recognition.

Finally, knowledge of the location, speed and direction of each ROI may be exploited in the subsequent recognition. For example, once an identity has been associated with a ROI with a sufficiently high accuracy, the size of the database searched may be adjusted downward in the interest of reducing processing time and improving matching accuracy.

1. An imaging device for producing optimal face images that combines the functionality of:
a. an imager consisting of sensing elements that can be individually addressed and controlled in real time
b. a processor to effect such control
c. an imager whose individually addressable sensing elements can be individually programmed for integration time, spectral sensitivity, dynamic range, frame rate, pixel binning, anti-bloom, amplifier gain and offset, and any other image quality or image generation parameter.
d. An imager that provides for dynamic grouping of sensing elements for sub-window regions of interest and fast focus.
e. software algorithms to find heads and faces, define and keep track of regions of interest containing faces, and dynamically and automatically optimize the critical imaging parameters for said regions containing faces.

2. The device will combine the functional components of claim 1 to provide imager control of specific regions in real time to ensure optimal face imaging results for each defined region.

3. Furthermore, the device of claim 1 is specifically intended for finding human heads and associated faces.

4. Furthermore, the device of claim 1 can be programmed to automatically and optimally image and track multiple heads simultaneously.

5. Furthermore, the device of claim 1 may generate regions of interest for each face that each may be transferred off the sensor and processed at dissimilar of frame rates.

6. Furthermore, the device of claim 1 may employ combining multiple frames in some fashion of a specific face region to suppress artifacts that detract from the desired face image quality, such as but not limited to electronic noise (as may be experienced in low light conditions).

7. The device of claim 1 may employ any combination of tracking and estimation techniques to aid in the dynamic definition of face region location and size by using all established means of tracking a target, such as but not limited to processing successive frames or video streams containing data such as historical face location, face velocity data, pose estimation, behavioral expectations, recursive filtering and obscured face tracking.

8. The technique in claim 7 may be enhanced to not only sustain face image quality as the face location migrates, but to improve face image quality by taking into account the imager system data and external environmental data for the location that the face will next be imaged within.
